(19) United States
(12) Patent Application Publication
(10) Pub. No.: US 2019/0143632 A1
(43) Pub. Date: May 16, 2019

(54) COMPOSITE CLOTH

(71) Applicants: Chen-Cheng HUANG, Taipei City (TW); Pao-Han HUANG, Taipei City (TW); Pao-Hao HUANG, Taipei City (TW)

(72) Inventors: Chen-Cheng HUANG, Taipei City (TW); Pao-Han HUANG, Taipei City (TW); Pao-Hao HUANG, Taipei City (TW)

(21) Appl. No.: 16/183,383

(22) Filed: Nov. 7, 2018

(30) Foreign Application Priority Data
Nov. 10, 2017 (TW) 106138922

(51) Int. Cl. B32B 3/30; B32B 3/26; B32B 5/02; B32B 27/40; B32B 27/12

(52) U.S. Cl. CPC B32B 3/30; B32B 3/266; B32B 27/12; B32B 27/40; B32B 5/024

(57) ABSTRACT

A composite cloth includes a fabric sheet and at least one functional film. The fabric sheet has opposite first and second surfaces and defines a plurality of micropores extending through the first and second surfaces. The at least one functional film is bonded to the first surface of the fabric sheet, conforms the first surface of the fabric sheet and is formed with a plurality of vacuum-molded protrusions extending into corresponding ones of the micropores. The at least one functional film has at least one functional component.

### CROSS-REFERENCE TO RELATED APPLICATION

This application claims priority of Taiwanese Invention Patent Application No. 106138922, filed on Nov. 10, 2017.

### FIELD

The disclosure relates to a composite cloth, and more particularly to a composite cloth including at least one functional film.

### BACKGROUND

A functional cloth having a predetermined function, such as waterproof, cool-feeling, anti-ultraviolet, etc., has been widely developed in recent years based on wearing requirements. One conventional method for making the functional cloth involves soaking a fabric sheet in a liquid substance containing functional components so as to bond the functional components and the fabric sheet. However, the functional components bonded to the fabric sheet will be in contact with a wearer's skin when the functional cloth is worn, which may result in an adverse effect on the wearer's health. Furthermore, the fabric sheet of the functional cloth may have poor durability due to the soaking method. Another conventional method for making the functional cloth involves coating the functional components on a surface of the fabric sheet. However, the functional components cannot be evenly distributed on the surface of the fabric sheet due to irregularity of the surface thereof, and the coated functional components may easily peel off from the fabric sheet and thus fail to function effectively.

### SUMMARY

Therefore, an object of the disclosure is to provide a composite cloth that can alleviate at least one of the drawbacks of the prior art.

According the disclosure, a composite cloth includes a fabric sheet and at least one functional film.

The fabric sheet has opposite first and second surfaces and defines a plurality of micropores extending through the first and second surfaces.

The at least one functional film is bonded to the first surface of the fabric sheet, conforms the first surface of the fabric sheet and is formed with a plurality of vacuum-molded protrusions extending into corresponding ones of the micropores.

The at least one functional film has at least one functional component.

### BRIEF DESCRIPTION OF THE DRAWINGS

Other features and advantages of the disclosure will become apparent in the following detailed description of the embodiments with reference to the accompanying drawings, of which:

FIG. 1 is a fragmentary exploded perspective view illustrating a first embodiment of a composite cloth according to the disclosure;

FIG. 2 is a fragmentary cross-sectional view illustrating the first embodiment;

FIG. 3 is a fragmentary cross-sectional view illustrating a second embodiment of the composite cloth according to the disclosure;

FIG. 4 is a fragmentary exploded perspective view illustrating a third embodiment of the composite cloth according to the disclosure;

FIG. 5 is a fragmentary cross-sectional view illustrating the third embodiment; and

FIG. 6 is a back view illustrating a fourth embodiment of the composite cloth according to the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

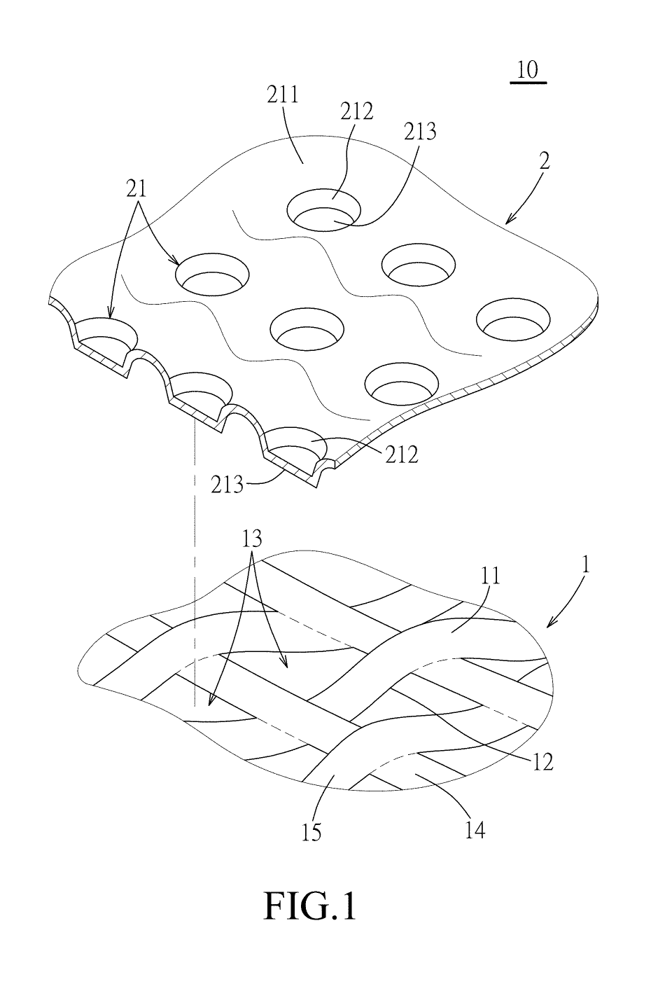

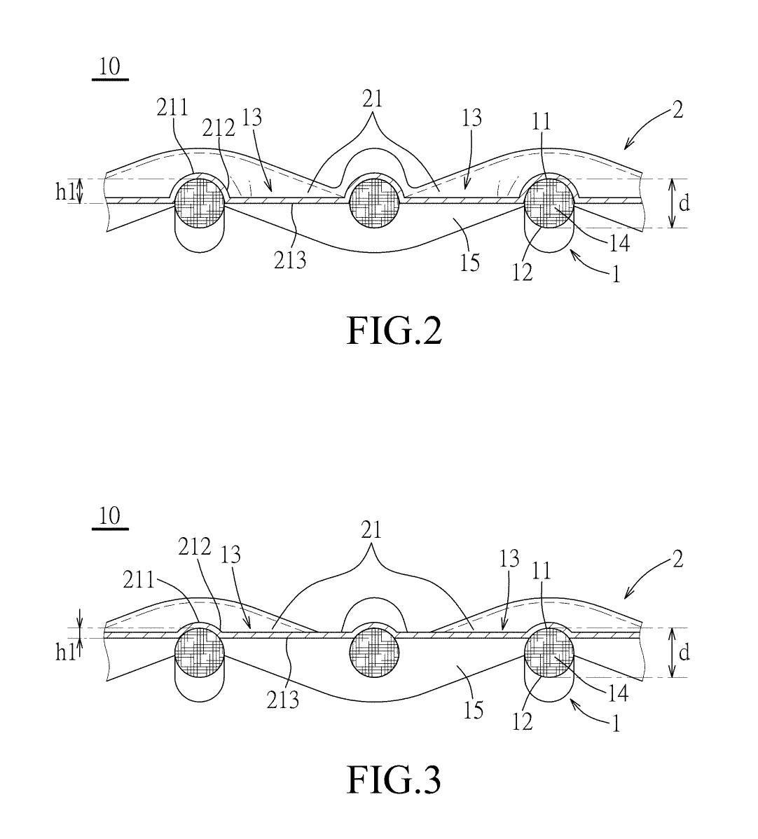

Referring to FIGS. 1 and 2, a first embodiment of a composite cloth 10 according to the disclosure includes a fabric sheet 1 and at least one functional film 2. In this embodiment, the composite cloth 10 is exemplified to include one functional film 2.

The fabric sheet 1 has opposite first and second surfaces 11, 12 and defines a plurality of micropores 13 that extend through the first and second surfaces 11, 12. The fabric sheet 1 may be made of a woven fabric, a nonwoven fabric or other suitable fabrics. In this embodiment, the fabric sheet 1 is made of the woven fabric and includes a plurality of warp yarns 14 and a plurality of weft yarns 15 interlaced with each other to define the micropores 13 thereamong.

In one form, the fabric sheet 1 has a multi-layered structure.

The functional film 2 is bonded to the first surface 11 of the fabric sheet 1, conforms the first surface 11 of the fabric sheet 1, and is formed with a plurality of vacuum-molded protrusions 21 extending into corresponding ones of the micropores 13. The functional film 2 has at least one functional component for providing a desired function. The functional film 2 may be made from a thermoplastic base material mixed with the functional component, and the thermoplastic base material may be selected from polyolefin, polyester, and a thermoplastic elastomer. In this embodiment, the thermoplastic base material of the functional film 2 is made from polyurethane elastomer. In one form, the functional component is not limited to be coated on a surface of the functional film 2.

More specifically, the functional film 2 includes a fabric-sheet binding portion 211 bonded to the first surface 11 of the fabric sheet 1, and a plurality of protrusion-forming portions 212 connected to the fabric-sheet binding portion 211 and respectively defining the vacuum-molded protrusions 21. Each of the vacuum-molded protrusions 21 has a closed end 213 distal to the first surface 11 of the fabric sheet 1.

The functional component of the functional film 2 may be selected from: an anti-ultraviolet (UV) component; a waterproof component; a vapor-permeable component, such as polyethylene oxide-modified polyurethane dispersion (PEO-modified PUD); an antistatic component; a water-repellent component, such as Teflon® textile finishes and Teflon® Fabric Protectors available from DuPont; a cooling component, such as such as erythritol and xylitol; an electromagnetic wave-shielding component, such as aluminum-containing phenol-formaldehyde resin; and combinations thereof. The selection of the functional component of the functional film 2 is based on practical requirements. The functional film 2 may have a plurality of the functional components, such that the functional film 2 has a plurality of the predetermined functions corresponding to the functional components.

To be specific, the first embodiment of the composite cloth 10 of the disclosure may be produced by disposing a raw functional film on the fabric sheet 1 with the micropores 13; placing the fabric sheet 1 and the raw functional film over a screen mold (not shown); heating the fabric sheet 1 and the raw functional film to soften the raw functional film; vacuum-forming the softened raw functional film with a suction force to form the functional film 2 provided with the vacuum-molded protrusions 21 extending into corresponding ones of the micropores 13, and melt-bonding the functional film 2 to the fabric sheet 1 so as to form the composite cloth 10; cooling the composite cloth 10; and releasing the composite cloth 10 from the screen mold. By way of the vacuum-molding techniques, the functional film 2 is entirely covered on the fabric sheet 1, and hardly peels off from the fabric sheet 1.

As shown in FIG. 2, each of the vacuum-molded protrusions 21 of the functional film 2 has a first height (h1) measured from the closed end 213 to the fabric-sheet binding portion 211. The first height (h1) of each of the vacuum-molded protrusions 21 is no less than half of a minimum distance (d) between the first and the second surfaces 11, 12 of the fabric sheet 1. Therefore, the closed ends 213 of the vacuum-molded protrusions 21 of the functional film 2, which are the closest areas of the functional film 2 to a wearer's skin, are isolatable from the wearer's skin.

Referring to FIG. 3, a second embodiment of the composite cloth 10 according to the disclosure is illustrated. The second embodiment of the composite cloth 10 has a structure similar to that of the first embodiment, except that the first height (h1) of each of the vacuum-molded protrusions 21 of the functional film 2 is adjusted to be less than that of the first embodiment, i.e., the height (h1) of each of the vacuum-molded protrusions 21 is less than half of the minimum distance (d) between the first and the second surfaces 11, 12 of the fabric sheet 1. Hence, a distance between the second surface 12 and the closed end 213 of each of the vacuum-molded protrusions 21 is larger than that of the first embodiment. Therefore, the functional film 2 is further isolated from the wearer's skin.

The second embodiment of the composite cloth 10 may be made in a manner similar to that of the first embodiment, except that the suction force applied to the raw functional film and the fabric sheet 1 is controlled to be smaller than the suction force applied for making the first embodiment. Hence, the first height (h1) of the vacuum-molded protrusions 21 is adjustable to be less than that of the first embodiment.

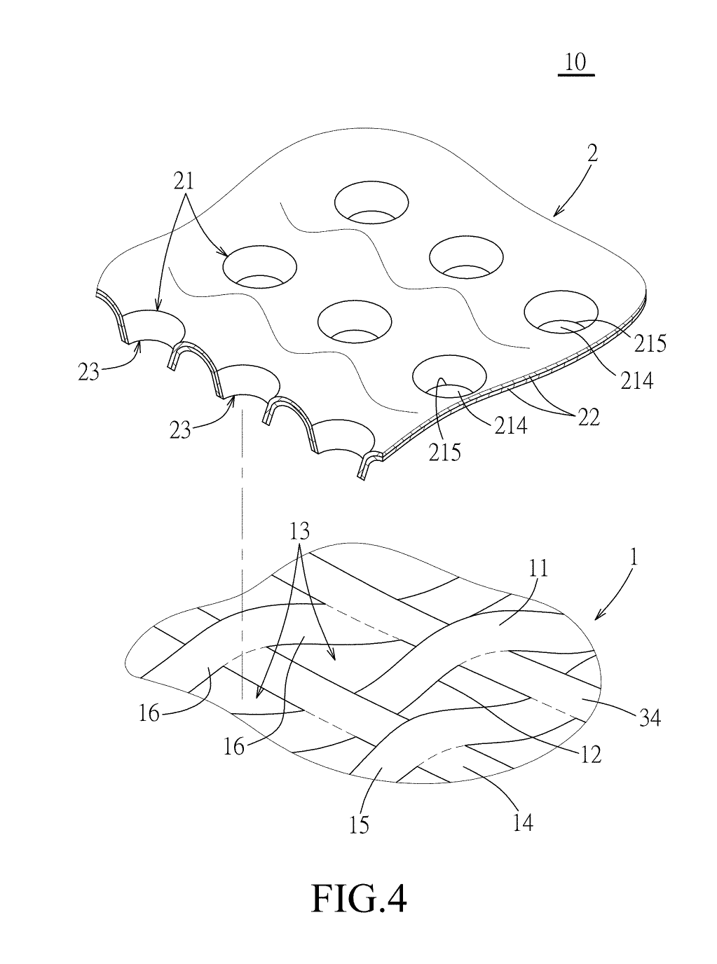

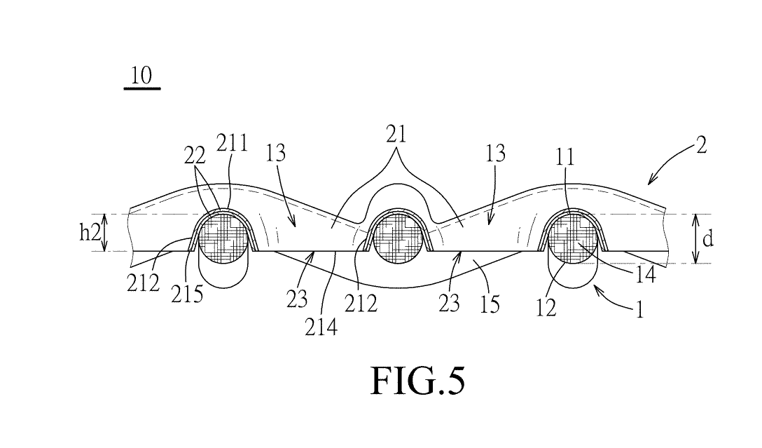

Referring to FIGS. 4 and 5, a third embodiment of the composite cloth 10 according to the disclosure is illustrated. The functional film 2 may include a plurality of functional layers 22 and a plurality of the functional components. Each of the functional layers 22 may have one or more of the functional components so that the functional film 2 is multi-functional. In this embodiment, the functional film 2 includes two of the functional layers 22 that are stacked on each other and that include two different ones of the functional components, respectively, such as the anti-ultraviolet component and the water-repellent component.

In this embodiment, each of the vacuum-molded protrusions 21 has an open end 214 distal to the first surface 11 of said fabric sheet 1. Each of the vacuum-molded protrusions 21 of the functional film 2 has a second height (h2) measured from a peripheral edge 215 surrounding the open end 214 to the fabric-sheet binding portion 211. The second height (h2) is greater than half of a minimum distance (d) between the first and second surfaces 11, 12 and less than the minimum distance (d) between the first and second surfaces 11, 12.

In this embodiment, the second height (h2) of each of the vacuum-molded protrusions 21 is increased, and a contact area between the fabric 1 and the functional film 2 is increased accordingly. Therefore, bonding strength between the functional film 2 and the fabric sheet 1 is further enhanced, and peeling of the functional film 2 from the fabric sheet 1 due to an external force can be avoided.

The third embodiment of the composite cloth 10 can be made in a manner similar to that of the first embodiment, except that the suction force applied to the raw functional film and the fabric sheet 1 is controlled to be greater than that applied for making the first embodiment. The open end 214 of each of the vacuum-molded protrusions 21 defines an opening 23 extending through the first and second surfaces 11, 12 of the fabric sheet 1 so as to improve vapor permeability of the composite cloth 10.

Alternatively, each of the vacuum-molded protrusions 21 of the third embodiment may be formed with a closed end 213 as with the first and second embodiments, and the closed end 213 of each of the vacuum-molded protrusions 21 of the first and second embodiments may be replaced with an open end 214 that defines an opening.

By controlling the suction force used in vacuum-molding for making the molded-vacuum protrusions 21, the first and second heights (h1, h2) of the vacuum-molded protrusions 21 are adjustable according to various requirements. When the first height (h1) is relatively small, i.e. the vacuum-molded protrusions 21 is relatively distal to the second surface 12, the vacuum-molded protrusions 21 will be isolated from the wearer's skin with a greater extent. With a precondition of isolating the functional film 2 from the wearer's skin, when the second height (h2) is relatively large, the contact area between the fabric sheet 1 and the protrusion-forming portion 212 of each of the vacuum-molded protrusions 21 is relatively increased, and the bonding strength between the functional film 2 and the fabric sheet 1 will be enhanced accordingly.

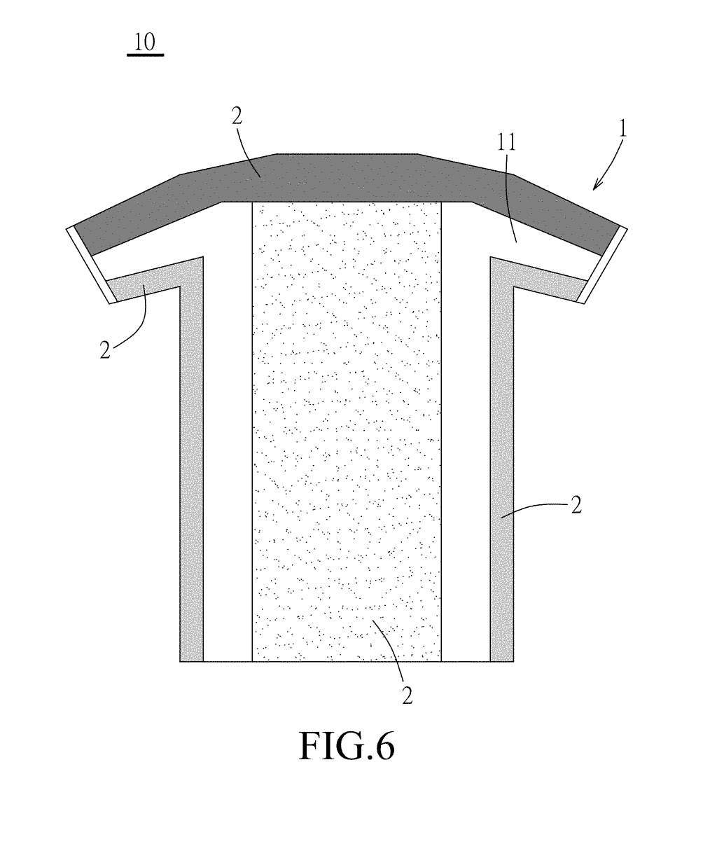

Referring to FIG. 6, a fourth embodiment of the composite cloth 10 according to the disclosure is illustrated. The composite cloth 10 is formed into a top clothing (only the back side thereof is shown). In this embodiment, the at least one functional film 2 is exemplified to include a plurality of the functional films 2 that are independently bonded to the first surface 11 of the fabric sheet 1. The first surface 11 of the fabric sheet 1 is an outer surface of the top clothing, and the second surface 12 of the fabric sheet 1 is an inner surface (not shown) of the top clothing. In this embodiment, four of the functional films 2 that are independently bonded to the fabric sheet 1 respectively have different ones of the above mentioned functional components. Hence, the top clothing has four different functional regions respectively corresponding in position to the four functional films 2. To be specific, the functional component included in one of the functional films 2 that is located at the shoulder part of the top clothing is the anti-ultraviolet component. The functional component included in another one of the functional films 2 that is located at the back part of the top clothing is the cooling component. The other two of the functional films 2 are respectively located at the sleeve regions of the top clothing, which respectively covers the wearer's arms from the armpits to the wrists or elbows. The other two functional films 2 include the vapor-permeable component. By way of designing the functional films 2 to be respectively placed at the different regions of the composite cloth 10, the composite cloth 10 has multiple functional regions that correspond in position to the different body parts of the wearer.

To sum up, by virtue of the structural design of the vacuum-molded protrusions 21 of the least one functional film 2 being bonded to the fabric sheet 1, the at least one functional film 2 including one or more of the functional component will not be in contact with the wearer's skin when the composite cloth 10 is worn. The composite cloth is made breathable with the openings 23 of the at least one functional film 2 corresponding in position to the micropores 13 of the fabric sheet 1. Furthermore, the position and number of the functional films 2 and the number of the functional layers 22 of each of the functional films 2 may be adjusted based on actual use so that the composite cloth 10 has multi-functional properties.

In the description above, for the purposes of explanation, numerous specific details have been set forth in order to provide a thorough understanding of the embodiments. It will be apparent, however, to one skilled in the art, that one or more other embodiments maybe practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A composite cloth, comprising:
a fabric sheet that has opposite first and second surfaces and that defines a plurality of micropores extending through said first and second surfaces; and
at least one functional film that is bonded to said first surface of said fabric sheet, that conforms said first surface of said fabric sheet and that is formed with a plurality of vacuum-molded protrusions extending into corresponding ones of said micropores,
wherein said at least one functional film has at least one functional component.

2. The composite cloth of claim 1, wherein said at least one functional film includes a fabric-sheet binding portion bonded to said first surface of said fabric sheet, and a plurality of protrusion-forming portions connected to said fabric-sheet binding portion and respectively defining said vacuum-molded protrusions, each of said vacuum-molded protrusions having a closed end distal to said first surface (11) of said fabric sheet.

3. The composite cloth of claim 2, wherein each of said vacuum-molded protrusions has a first height that is measured from said closed end to said fabric-sheet binding portion, the first height being less than half of a minimum distance between said first and second surfaces.

4. The composite cloth of claim 2, wherein each of said vacuum-molded protrusions has a first height that is measured from said closed end to said fabric-sheet binding portion, the first height being no less than half of a minimum distance between said first and second surfaces.

5. The composite cloth of claim 1, wherein said at least one functional film has a fabric-sheet binding portion bonded to said first surface of said fabric sheet, and a plurality of protrusion-forming portions respectively defining said vacuum-molded portions, each of said vacuum-molded protrusions having an open end distal to said first surface of said fabric sheet.

6. The composite cloth of claim 5, wherein each of said vacuum-molded protrusions of said at least one functional film has a second height measured from a peripheral edge surrounding said open end to said fabric-sheet binding portion, the second height being greater than half of a minimum distance between said first and second surfaces and less than the minimum distance between said first and second surfaces.

7. The composite cloth of claim 1, wherein said at least one functional film has a plurality of the functional components and a plurality of functional layers that are stacked on top of each other, each of said functional layers having one or more of the functional components.

8. The composite cloth of claim 1, wherein said at least one functional film includes a plurality of said functional films that are independently bonded to said first surface of said fabric sheet.

9. The composite cloth of claim 1, wherein the functional component of said at least one functional films is selected from the group consisting of an anti-ultraviolet (UV) component, waterproof component, a vapor-permeable component, an antistatic component, a water-repellent component, a cooling component, an electromagnetic wave-shielding component, and combinations thereof.

10. The composite cloth of claim 1, wherein said fabric sheet is made of one of a woven fabric and a nonwoven fabric.

11. The composite cloth of claim 10, wherein said fabric sheet is made of the woven fabric and includes a plurality of warp yarns and a plurality of weft yarns interlaced with each other to define said micropores thereamong.

12. The composite cloth of claim 1, wherein said functional film is made from a thermoplastic base material mixed with the functional component, said thermoplastic base material being selected from polyolefin, polyester, and a thermoplastic elastomer.

13. The composite cloth of claim 12, wherein said thermoplastic base material is made from polyurethane elastomer.
